(19) United States
(12) Patent Application Publication
(10) Pub. No.: US 2026/0195285 A1
(43) Pub. Date: Jul. 9, 2026

(54) Method and Apparatus for Interface Communication, and Server

(71) Applicant: SUZHOU METABRAIN INTELLIGENT TECHNOLOGY CO., LTD., Suzhou, Jiangsu (CN)

(72) Inventors: Chaofan CHEN, Suzhou, Jiangsu (CN); Jinming LIU, Suzhou, Jiangsu (CN); Xingjuan DI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/133,535

(22) PCT Filed: May 27, 2024
(86) PCT No.: PCT/CN2024/095585

§ 371 Date: May 28, 2025

(30) Foreign Application Priority Data
Aug. 28, 2023 (CN) 202311090170.9

(51) Int. Cl. G06F 13/42

(52) U.S. Cl. CPC G06F 13/42; G06F 2213/40

(57) ABSTRACT

A method and an apparatus for interface communication, and a server. A host system includes a plurality of hardware partitions, each of the hardware partitions includes a first interface, a baseboard management controller (BMC) includes a plurality of kernel partitions, part of the kernel partitions each includes a second interface, and an interface type of the first interface is different from that of the second interface. The method includes: generating a control instruction to control the hardware partition; converting the control instruction into an interface signal of the first interface through the second interface according to a predetermined interface protocol; and transmitting the interface signal to the first interface through the second interface.

### CROSS-REFERENCE TO RELATED APPLICATION

The present application claims the priority of Chinese Patent Application No. 202311090170.9, filed with the Chinese Patent Office on Aug. 28, 2023 and entitled “Method and apparatus for interface communication, and server”, which is incorporated in its entirety herein by reference.

### TECHNICAL FIELD

Examples of the present application relate to the field of computers, and particularly relate to a method and apparatus for interface communication, and a server.

### BACKGROUND

With the rapid development of the semiconductor industry and the integrated circuit technology in recent years, a processor has become an essential computing unit for cloud computing, artificial intelligence, big data and other fields. In order to share hardware computing resources and improve the utilization of multi-core processors, the virtualization technology is introduced conventionally, that is, a large number of virtual machines are virtualized based on a processor hardware platform, and each virtual machine runs one independent operating system. However, a virtual machine-based operating system is generally unable to satisfy real-time service requirements due to additional overhead of virtual machine management and the like. As a result, the operating system is usually run directly with an exclusive physical machine. Service processing latency can be significantly reduced by use of such “bare-metal” processors. In the field of the server industry, the hardware partitioning technology for computing resources such as a central processing unit (CPU) of a general-purpose host system emerges. A single server is partitioned into two or more physical host systems that individually host services to provide services. This presents difficulties and challenges to the system design of a server management unit (baseboard management controller, BMC), and especially the problems faced in the design of a platform environment control interface (PECI) link for the BMC are acute. In order to guarantee the long-term stable and efficient operation of a server, a server system must have powerful fault monitoring and managing functions. Since a typical server is usually configured with only one BMC management unit, that is, there is only one PECI, so in a scenario of server hardware partition systems, the hardware partition systems cannot independently use the PECI, thus impacting the independence of the fault managing functions of different partition systems of the same server platform.

An existing solution is to upgrade a CPU architecture of the BMC, that is, to redesign the PECI module for multi-hardware partition systems of a host system. However, this solution poses two challenges. First, because hardware partition design within the BMC is required by the upgrade of the CPU architecture of the BMC, the design complexity increases significantly, and a dramatic increase in chip costs will inevitably be produced. Second, because chip design, chip flow, manufacturing, debugging and other aspects of the upgrade of the CPU architecture of the BMC will occupy a large proportion of time cycles, a serious impact will be exerted on application and promotion of the hardware partitioning technology for a host system, and rapid promotion and application of the new technology will be hindered.

### SUMMARY

Examples of the present application provide a method and apparatus for interface communication, and a server, so as to solve a problem of complex design of a baseboard management controller (BMC) chip in a host system hardware partition scenario in the related art.

According to an example of the present application, a method for interface communication is provided. A host system of a server includes a hardware partition, a baseboard management controller (BMC) includes a kernel partition, the kernel partition is configured to manage the hardware partition, and the method includes: generating a control instruction for controlling the hardware partition; converting the control instruction into an interface signal conforming to a predetermined interface protocol, wherein the predetermined interface protocol is an interface protocol of a first interface of the hardware partition; and transmitting the interface signal to the first interface through a second interface, wherein an interface type of the first interface is different from an interface type of the second interface.

In an illustrative example, the converting the control instruction into an interface signal conforming to a predetermined interface protocol includes: determining a plurality of pieces of logic bit information corresponding to the control instruction according to the predetermined interface protocol; and generating the interface signal according to the plurality of pieces of logic bit information, a first timer, and a second timer.

In an illustrative example, the generating the interface signal according to the plurality of pieces of logic bit information, a first timer and a second timer includes: determining timing duration of the first timer and timing duration of the second timer according to the plurality of pieces of logic bit information; and generating the interface signal through the second interface according to the timing duration of the first timer and the timing duration of the second timer.

In an illustrative example, the determining timing duration of the first timer and timing duration of the second timer according to the plurality of pieces of logic bit information includes: obtaining first duration and second duration corresponding to each piece of logic bit information in the plurality of pieces of logic bit information, wherein the first duration represents duration in which the each piece of logic bit information is at a high level (in embodiments of present disclosure, the high level can represent 1 (“1” can be a logic “1”, which indicates 3.3V, or 5V or an other preset voltage value), the low level can represent 0 (“0” can be a logic “0” which indicates 0 V or an other preset voltage value)), the second duration represents total duration of the each piece of logic bit information, and the first duration corresponding to different pieces of logic bit information in the plurality of pieces of logic bit information is different; and determining that the timing duration of the first timer is the first duration, and determining that the timing duration of the second timer is the second duration.

In an illustrative example, the generating the interface signal through the second interface according to the timing duration of the first timer and the timing duration of the second timer includes: sequentially generating, by the second interface, an interface sub-signal corresponding to each piece of logic bit information in the plurality of pieces of logic bit information in an order of the plurality of pieces of logic bit information according to the first duration of the first timer and the second duration of the second timer, to obtain the interface signal.

In an illustrative example, the sequentially generating, by the second interface, an interface sub-signal corresponding to the each piece of logic bit information in the plurality of pieces of logic bit information in an order of the plurality of pieces of logic bit information according to the first duration of the first timer and the second duration of the second timer, to obtain the interface signal include: a control step: controlling the first timer and the second timer to start timing, and outputting a first signal through the second interface before the timing duration of the first timer reaches the first duration; an output step: outputting a second signal through the second interface after the timing duration of the first timer reaches the first duration and before the timing duration of the second timer reaches the second duration, to obtain the interface sub-signal composed of the first signal and the second signal; a count step: performing a timing counting operation in a case that the timing duration of the second timer reaches the second duration; and a determination step: determining whether a timing counting value obtained from the timing counting operation is less than a total number of the plurality of pieces of the logic bit information; in a case that the timing counting value is less than the total number of the plurality of pieces of logic bit information, sequentially performing the control step, the output step, and the count step in the order until the timing counting value is not less than the total number of the plurality of pieces of logic bit information, to obtain the interface signal comprising a plurality of interface sub-signals.

In an illustrative example, the method further includes: initializing an output signal of the second interface to a low level before the control step, the low level represents 0.

In an illustrative example, the control step includes: controlling the first timer and the second timer to start timing; setting an output signal of the second interface to a high level, and outputting the first signal at the high level through the second interface, the high level represents 1; and in a case that the timing duration of the first timer reaches the first duration, stopping outputting the first signal and setting an output signal of the second interface to a low level, the low level represents 0.

In an illustrative example, in a case that the timing duration of the first timer reaches the first duration, the stopping outputting the first signal includes: triggering a first interruption in the case that the timing duration of the first timer reaches the first duration to stop outputting the first signal.

In an illustrative example, the output step includes: in a case that the timing duration of the first timer reaches the first duration, setting an output signal of the second interface to a low level, and outputting the second signal in the low level through the second interface, the low level represents 0; and in a case that the timing duration of the second timer reaches the second duration, stopping outputting the second signal, and setting an output signal of the second interface to a high level to obtain the interface sub-signal, the high level represents 1.

In an illustrative example, in a case that the timing duration of the second timer reaches the second duration, the stopping outputting the second signal includes: triggering a second interruption in the case that the timing duration of the second timer reaches the second duration to stop outputting the second signal.

In an illustrative example, the control instruction includes at least one of the following: a first instruction, configured to determine whether the hardware partition exists; a second instruction, configured to obtain a sensor temperature of the hardware partition; and a third instruction, configured to obtain register data of the hardware partition.

In an illustrative example, a data structure of the control instruction includes an address rate field, a target address field, a message rate field, a write length field and a read length field, wherein the address rate field represents a transmission rate of address data, the target address field represents address data of the hardware partition, and the message rate field represents a transmission rate of message data.

In an illustrative example, after the transmitting the interface signal to the first interface through a second interface, the method further includes: receiving a response instruction generated by the hardware partition in response to the control instruction, wherein the response instruction includes the control instruction and a frame check field.

In an illustrative example, the first interface includes a platform environment control interface (PECI), and the second interface includes a general-purpose input/output (GPIO) interface.

In an illustrative example, the quantity of the hardware partition in the host system is more than one, the quantity of the kernel partition in the BMC is more than one, one kernel partition of more than one kernel partitions includes a third interface, the other kernel partitions, excluding the one kernel partition, of the more than one kernel partitions each includes the second interface, each of more than one hardware partitions includes the first interface, an interface type of the third interface is identical to an interface type of the first interface, and the method further includes: transmitting the control instruction to the corresponding first interface through the third interface.

According to another example of the present application, an apparatus for interface communication is provided. A host system of a server includes a hardware partition, a baseboard management controller (BMC) includes a kernel partition, the kernel partition is configured to manage the hardware partition, and the apparatus includes: a generation unit configured to generate a control instruction for controlling the hardware partition; a conversion unit configured to convert the control instruction into an interface signal conforming to a predetermined interface protocol, wherein the predetermined interface protocol is an interface protocol of a first interface of the hardware partition; and a first transmission unit configured to transmit the interface signal to the first interface through a second interface, wherein an interface type of the first interface is different from an interface type of the second interface.

According to yet another example of the present application, a non-volatile readable storage medium is further provided. The non-volatile readable storage medium stores a computer program. The computer program is configured to execute steps of any one of the above method examples when run.

According to yet another example of the present application, an electronic device is further provided. The electronic device includes a memory and a processor, where the memory stores a computer program, and the processor is configured to execute steps of any one of the above method examples when running the computer program.

According to still another example of the present application, a server is further provided. The server includes: a host system comprising a plurality of hardware partitions, wherein each of the plurality of hardware partitions comprise a first interface; and a baseboard management controller (BMC) comprising a plurality of kernel partitions, wherein the plurality of kernel partitions correspond one-to-one with the plurality of hardware partitions, at least part of the plurality of kernel partitions each comprise a second interface, an interface type of the first interfaces is different from an interface type of the second interface, and each of at least part of the plurality of kernel partitions is configured to generate a control instruction to control a corresponding hardware partition in the plurality of hardware partitions; and convert the control instruction into an interface signal conforming to a predetermined interface protocol, wherein the predetermined interface protocol is an interface protocol of the first interface of each of the plurality of the hardware partitions; and transmit the interface signal to the first interface through the second interface.

In an illustrative example, each of at least part of the plurality of kernel partitions is further configured to determine a plurality of pieces of logic bit information corresponding to the control instruction according to the predetermined interface protocol, and generate the interface signal according to the plurality of pieces of logic bit information, a first timer and a second timer.

In an illustrative example, each of at least part of the plurality of kernel partitions is further configured to determine timing duration of the first timer and timing duration of the second timer according to the plurality of pieces of logic bit information, and generate the interface signal through the second interface according to the timing duration of the first timer and the timing duration of the second timer.

In an illustrative example, each of at least part of the plurality of kernel partitions is further configured to obtain first duration and second duration corresponding to each piece of logic bit information in the plurality of pieces of logic bit information, wherein the first duration represents duration in which the each piece of logic bit information is at a high level, the high level represents 1, the second duration represents total duration of the each piece of logic bit information, and the first duration corresponding to different pieces of logic bit information in the plurality of pieces of logic bit information is different; and determine that the timing duration of the first timer is the first duration, and determine that the timing duration of the second timer is the second duration.

In an illustrative example, each of at least part of the plurality of kernel partitions is further configured to sequentially generate, by the second interface, an interface sub-signal corresponding to each piece of logic bit information in the plurality of pieces of logic bit information through the second interface in an order of the plurality of pieces of logic bit information according to the first duration of the first timer and the second duration of the second timer, to obtain the interface signal.

In an illustrative example, one kernel partition of the plurality of kernel partitions includes a third interface, an interface type of the third interface is identical to an interface type of the first interfaces, the other kernel partitions, excluding the one kernel partition, in the plurality of kernel partitions each includes the second interface, and the one kernel partition comprising the third interface is configured to transmit the control instruction to the corresponding first interface through the third interface.

According to the present application, hardware logic design of a PECI controller does not need to be implemented on a BMC chip in advance, and the interface signal can be generated on the BMC chip only by simulating the interface protocol of the first interface through the second interface by the kernel partition. Accordingly, a technical effect of simulating and generating a hardware interface signal in a software mode is achieved, and then a purpose of hardware logic design without the chip itself having relevant hardware interface signals is further achieved. Not only design difficulty of the BMC chip can be reduced, design cost and a design cycle of the BMC chip can be reduced, and an effect that one kernel partition of the BMC independently manages one hardware partition in the host system can also be achieved. Thus expansion of a communication link between the BMC and the host system is implemented, and then a purpose that one BMC chip independently controls the plurality of hardware partitions of the host system can be achieved.

### BRIEF DESCRIPTION OF THE DRAWINGS

FIG. 1 is a schematic diagram of a computer terminal according to an example of the present application;

FIG. 2 is a flowchart of a method for interface communication according to an example of the present application;

FIG. 3 is a schematic diagram of waveforms corresponding to logic bits according to an example of the present application;

FIG. 4 is a schematic diagram of a message transmission format of a response instruction according to an example of the present application;

FIG. 5 is a flowchart of generating interface information according to an example of the present application;

FIG. 6 is a block diagram of an apparatus for interface communication according to an example of the present application; and

FIG. 7 is a schematic structural diagram of a server according to an example of the present application.

The drawings include the following reference numerals:

02. processor; 04. memory; 06. transmission device; 08. input/output device; 100. host system; 101. hardware partition; 102. first interface; 200. BMC; 201. kernel partition; 202. second interface; and 203. third interface.

### DETAILED DESCRIPTION OF THE EMBODIMENTS

Examples of the present application will be described in detail below in conjunction with the accompanying drawings and the examples.

It should be noted that the terms “first”, “second” and so forth in the specification and claims of the present application and in the above-mentioned drawings are used to distinguish between similar objects and not necessarily to describe a particular order or sequential order.

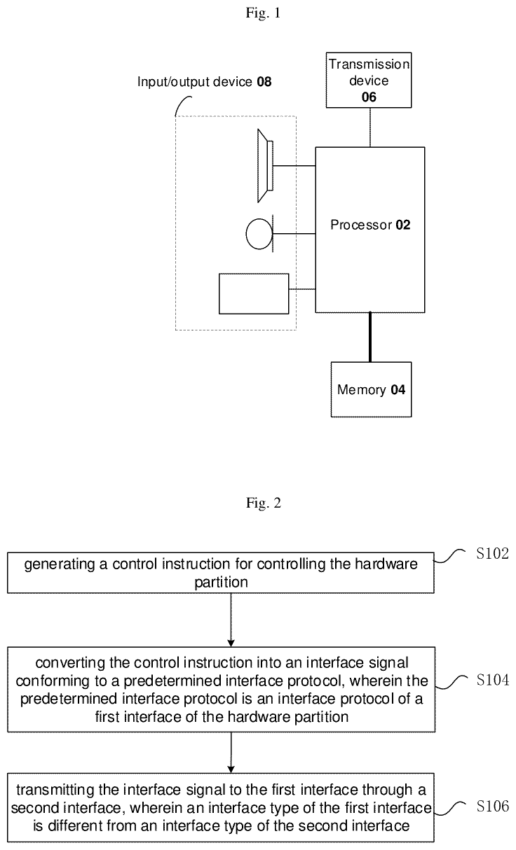

A method example according to the example of the present application may be executed in a mobile terminal, a computer terminal, or a similar computing apparatus. With running on the mobile terminal as an instance, FIG. 1 is a structural block diagram of hardware of a mobile terminal of a method for interface communication according to an example of the present application. As shown in FIG. 1, the mobile terminal may include one or more processors 02 (only one processor is shown in FIG. 1) and a memory 04 configured to store data. The processors 02 may include, but are not limited to, processing apparatuses such as a microcontroller unit (MCU) or a field-programmable gate array (FPGA). The above mobile terminal may further include a transmission device 06 configured to play a role in communication and an input/output device 08. Those of ordinary skill in the art can understand that the structure shown in FIG. 1 is merely illustrative, and does not limit the structure of the above mobile terminal. For example, the mobile terminal may further include more or fewer components than those shown in FIG. 1, or have a configuration differing from that shown in FIG. 1.

The memory 04 may be configured to store a computer program, for example, a software program and a module of application software, such as a computer programs corresponding to the method for interface communication in the example of the present application. The processor 02 runs the computer program stored in the memory 04 to execute various functional applications and data processing, that is, realize the above method. The memory 04 may include a high-speed random access memory, and may further include a non-volatile memory, such as one or more magnetic storage apparatuses, flash memories, or other non-volatile solid-state memories. In some instances, the memory 04 may further include memories remotely configured relative to the processor 02, where these remote memories may be connected with the mobile terminal through a network. The instances of the network include, but are not limited to, the Internet, an intranet, a local area network, a mobile communication network, and their combinations.

The transmission device 06 is configured to receive or transmit data via one network. The optional instances of the above network may include a wireless network provided by a communication provider of the mobile terminal. In an instance, the transmission device 06 includes a network interface controller (NIC), which may be connected to other network devices through a base station to communicate with the Internet. In an instance, the transmission device 06 may be a radio frequency (RF) module, which is configured to communicate with the Internet wirelessly.

A method for interface communication is provided in the example. A host system of a server includes a hardware partition, a baseboard management controller (BMC) comprises a kernel partition, the kernel partition is configured to manage the hardware partition. The method is applied to the kernel partition. FIG. 2 is a flowchart of the method for interface communication according to the example of the present application. As shown in FIG. 2, a flow includes the following steps.

S102, generating a control instruction for controlling the hardware partition.

In some examples, the control instruction includes at least one of the following: a first instruction used for determining whether the hardware partition exists; a second instruction used for obtaining a sensor temperature of the hardware partition; and a third instruction used for obtaining register data of the hardware partition.

S104, converting the control instruction into an interface signal conforming to a predetermined interface protocol, wherein the predetermined interface protocol is an interface protocol of a first interface of the hardware partition.

In some examples, the interface signal may be a platform environment control interface (PECI) signal or an interface signal of another protocol type.

S106, transmitting the interface signal to the first interface through a second interface, wherein an interface type of the first interface is different from an interface type of the second interface.

In some examples, the first interface may include a PECI, and the second interface may include a general-purpose input/output (GPIO) interface. For example, the first interface is a PECI, and the second interface is a GPIO interface.

Through the above steps, in the scenario of hardware partition of the host system of the server, the control instruction to control the hardware partition is firstly generated through the kernel partition of the BMC. Then the control instruction is converted to obtain the interface signal conforming to the interface protocol of the first interface of the hardware partition. Finally, the obtained interface signal is transmitted to the first interface through the second interface, so as to control one hardware partition of the host system. Compared with the problems that a BMC chip needs to be provided with hardware logic design of a PECI controller in the scenario of the hardware partition of the host system in the related art, thereby causing complex design of the BMC chip, in the present application, the hardware logic design of the PECI controller does not need to be implemented on the BMC chip in advance, and the interface signal can be generated on the BMC chip only by simulating the interface protocol of the first interface through the second interface by the kernel partition. Accordingly, the technical effect of simulating and generating a hardware interface signal in a software mode is achieved, and then a purpose of hardware logic design without the chip itself having relevant hardware interface signals is further achieved. Not only design difficulty of the BMC chip can be reduced, design cost and a design cycle of the BMC chip can be reduced, and an effect that one kernel partition of the BMC independently manages one hardware partition in the host system can also be achieved. Thus expansion of a communication link between the BMC and the host system is implemented, and then a purpose that one BMC chip independently controls the plurality of hardware partitions of the host system can be achieved.

An execution entity of the above steps may be, but is not limited to, a terminal, a processor, etc.

In an illustrative example, the converting the control instruction into an interface signal conforming to a predetermined interface protocol includes: determining a plurality of pieces of logic bit information corresponding to the control instruction according to the predetermined interface protocol; and generating the interface signal according to the plurality of pieces of logic bit information, a first timer, and a second timer. In the example, the interface signal corresponding to the control instruction is generated according to the predetermined interface protocol, such that a technical effect of generating the interface signal of the first interface by simulation in a software mode is further achieved.

In order to generate the interface signal corresponding to the control instruction according to the plurality of pieces of logic bit information, the first timer and the second timer, according to some optional examples of the present application, the generating the interface signal according to the plurality of pieces of logic bit information, a first timer and a second timer includes: determining timing duration of the first timer and timing duration of the second timer according to the plurality of pieces of logic bit information; and generating the interface signal through the second interface according to the timing duration of the first timer and the timing duration of the second timer.

In some examples, the first timer and the second timer may be a timer program in the kernel partition or a register on the kernel partition. The first timer and the second timer may at least provide a timing function.

In another illustrative example, the determining timing duration of the first timer and timing duration of the second timer according to the plurality of pieces of logic bit information includes: obtaining first duration and second duration corresponding to each piece of logic bit information in the plurality of pieces of logic bit information, wherein the first duration represents duration in which the each piece of logic bit information is at a high level (in embodiments of present disclosure, the high level can represent 1 (“1” can be a logic “1”, which indicates 3.3V, or 5V or an other preset voltage value), the low level can represent 0 (“0” can be a logic “0” which indicates 0 V or an other preset voltage value)); the second duration represents total duration of the each piece of logic bit information, and the first duration corresponding to different pieces of logic bit information in the plurality of pieces of logic bit information is different; and determining that the timing duration of the first timer is the first duration, and determining that the timing duration of the second timer is the second duration. In the example, by setting the timing duration of the first timer to be the first duration and the timing duration of the second timer to be the second duration, it is convenient to generate the logic bit information corresponding to different logic bits according to the timing duration of the first timer and the second timer subsequently, and then to obtain the interface signal. The purpose of generating the interface signal by using a software system on the basis of not requiring hardware logic design of the interface signal for the BMC chip is further achieved. Thus the design difficulty of the BMC chip is further reduced.

The first duration is shorter than the second duration.

In some examples, the control instruction is composed of at least one field. The field is represented by a plurality of logic bits. Each logic bit may be 0 or 1. Each logic bit is converted into the corresponding logic bit information, that is, the interface signal corresponding to the control instruction is obtained. The logic bit information may be represented by a combination of a high level signal and a low level signal. For example, logic bit 0 may be represented by a combination of a high level signal of first preset duration and a low level signal of second preset duration, and logic bit 1 may be represented by a combination of a high level signal of third preset duration and a low level signal of fourth preset duration. The first preset duration is different from the third preset duration, and the second preset duration is different the fourth preset duration.

Generally speaking, under an interface protocol, running duration corresponding to each piece of logic bit information in the plurality of pieces of logic bit information is the same, that is, the second duration corresponding to each piece of logic bit information is the same. Thus a sum of the first preset duration and the second preset duration is equal to a sum of the third preset duration and the fourth preset duration.

In an actual application process, an order exists among the plurality of pieces of logic bit information. In order to further guarantee that the interface signal corresponding to the control instruction is obtained more accurately, in yet another optional example of the present application, the generating the interface signal through the second interface according to the timing duration of the first timer and the timing duration of the second timer includes: sequentially generating, by the second interface, an interface sub-signal corresponding to each piece of logic bit information in the plurality of pieces of logic bit information in an order of the plurality of pieces of logic bit information according to the first duration of the first timer and the second duration of the second timer, to obtain the interface signal.

In some examples, the interface sub-signal is actually a waveform signal composed of a high level signal and a low level signal. A plurality of waveform signals form the interface signal.

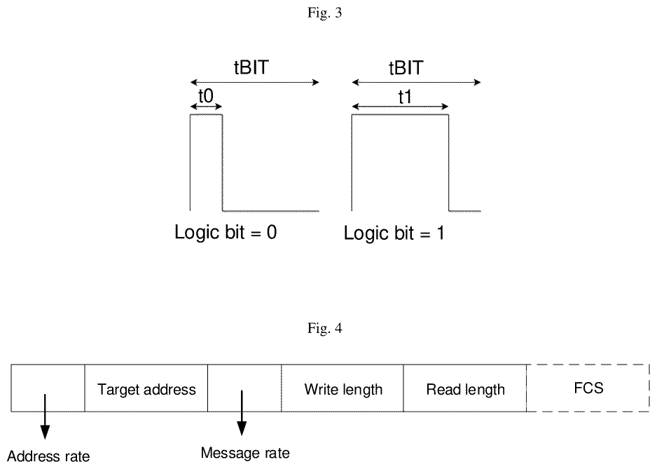

In some examples, as shown in FIG. 3, when the logic bit is 0, the first duration corresponding to the first timer is t0. When the logic bit is 1, the first duration corresponding to the first timer is t1, and to is less than t1. The second duration is tBIT. Generally, t0 is 0.6 time to 0.8 time tBIT, that is, t0=0.2 tBIT to 0.4 tBIT, and t1 is 0.6 time to 0.8 time tBIT, that is, t1=0.6 tBIT to 0.8 tBIT.

In an illustrative example, the sequentially generating, by the second interface, an interface sub-signal corresponding to the each piece of logic bit information in the plurality of pieces of logic bit information in an order of the plurality of pieces of logic bit information according to the first duration of the first timer and the second duration of the second timer, to obtain the interface signal includes:
a control step: controlling the first timer and the second timer to start timing, and outputting a first signal through the second interface before the timing duration of the first timer reaches the first duration.

In some examples, the first timer and the second timer each include a down counter. An initial value of the first timer is set to the first duration. An initial value of the second timer is set to the second duration. When the first timer and the second timer start timing, the down counters start to decrease from the initial value to 0, and trigger interruptions of the first timer and the second timer when reaching 0. The initial value of the first timer is reset to the first duration. The initial value of the second timer is reset to the second duration. Then countdown is performed again. The interruption may be understood as an identifier, and thus the interruption may also be referred to as an interrupt identifier.

In some examples, the first signal is a high level signal. In the present application, in order to convert logic bit 0 or 1 into a corresponding interface sub-signal, the first signal in a high level is generated through the second interface before the timing duration of the first timer reaches the first duration.

The operation further includes an output step: outputting a second signal through the second interface after the timing duration of the first timer reaches the first duration and before the timing duration of the second timer reaches the second duration, to obtain the interface sub-signal composed of the first signal and the second signal.

In some examples, the second signal is a low level signal. In the present application, in order to distinguish between logic bits 0 and 1, after the timing duration of the first timer reaches the first duration, the second signal in a low level is generated through the second interface. Until the timing duration of the second timer reaches the second duration, interface sub-signals of different waveforms are obtained. Waveform signals corresponding to the logic bits 0 and 1 have different duty ratios.

The operation further includes a count step: performing a timing counting operation in a case that the timing duration of the second timer reaches the second duration.

In some examples, the timing counting may be performed once as follows: one is added to an original timing counting value.

The operation further includes a determination step: determining whether a timing counting value obtained from the timing counting operation is less than a total number of the plurality of pieces of the logic bit information; in a case that the timing counting value is less than the total number of the plurality of pieces of logic bit information, sequentially performing the control step, the output step, and the count step in the order until the timing counting value is not less than the total number of the plurality of pieces of logic bit information, to obtain the interface signal comprising a plurality of interface sub-signals.

In the above example, the first timer and the second timer are configured in the order of the logic bits and controlled to start. The first signal and the second signal corresponding to the timing duration of the first timer and the second timer are output according to the timing duration of the first timer and the second timer. Thus the duration of the waveform signals corresponding to the logic bits are controlled, and the effect of sequentially simulating the plurality of interface sub-signals in a software manner to obtain the interface signal is further achieved.

The method further includes: initializing an output signal of the second interface to a low level before the control step. embodiments of present disclosure, the high level can represent 1 (“1” can be a logic “1”, which indicates 3.3V, or 5V or an other voltage value preset in the circuit), the low level can represent 0 (“0” can be a logic “0” which indicates 0 V or an other voltage value preset in the circuit).

In an actual application process, before the plurality of pieces of logic bit information corresponding to the control instruction are determined according to the predetermined interface protocol, the method further includes: the control instruction composed of the plurality of logic bits is stored into an array variable, where a data stream length of the array variable is greater than or equal to a number of the logic bits, and each logic bit is stored in the array variable in a sorting order; and an index variable of the logic bits is set, where the index variable is used for indexing the logic bits corresponding to positions from the array variable. In this way, in a subsequent process of determining the plurality of pieces of logic bit information corresponding to the control instruction according to the predetermined interface protocol, the logic bits may be sequentially read from the array variable in the order of the logic bits, and the corresponding logic bit information may be determined.

Then, the plurality of pieces of logic bit information corresponding to the control instruction are determined according to the predetermined interface protocol as follows: an indexing step: a logic bit to be converted is obtained from the array variable according to the index variable; and a second determination step: logic bit information corresponding to the logic bit to be converted is determined according to the predetermined interface protocol.

After the index variable of the logic bit is set and before the logic bit to be converted is obtained from the array variable according to the index variable, the method further includes: the index variable is initialized to 0.

In the above example, a step that the first duration and the second duration corresponding to each piece of logic bit information are obtained is taken as an obtaining step. Steps that the first duration is determined as the timing duration of the first timer, and the second duration is determined as the timing duration of the second timer are taken as a fourth determination step. A step that the interface sub-signal corresponding to each piece of logic bit information is sequentially generated through the second interface in the order of the plurality of pieces of logic bit information according to the first duration of the first timer and the second duration of the second timer is taken as a generation step. The method may further include an accumulation step: one is added to the index variable to obtain an updated index variable when the timing duration of the second timer reaches the second duration. The method further includes: a third determination step: whether the updated index variable is less than the total number of the logical bits is determined, in a case that the updated index variable is less than the total number of the logical bits, the indexing step, the second determination step, the obtaining step, the fourth determination step, and the generation step are sequentially performed until the index variable is not less than the number of the logical bits. That is to say, the logic bits are sequentially read from the array variable through the index variable. The first duration and the second duration corresponding to a read logic bit are obtained, the timing duration of the first timer and the second timer is obtained. Finally the first timer and the second timer are controlled to start timing according to the timing duration. The interface sub-signals corresponding to the logic bit information are sequentially generated through the second interface. The interface sub-signals are further generated in order. Thus a more accurate interface signal can be obtained.

The order of the logic bits refers to the order of logic bits constituting the control instruction. In a case that the logic bits corresponding to the control instruction include logic bit 1, logic bit 2, logic bit 3, . . . , and logic bit n in order, and corresponding index variables include index variable 0, index variable 1, index variable 2, . . . , and index variable n−1, interface sub-signals corresponding to logic bit 1, logic bit 2, logic bit 3, . . . , and logic bit n are sequentially generated through a loop process, that is, interface sub-signal 1, interface sub-signal 2, interface sub-signal 3, . . . , and interface sub-signal n are obtained, and the interface signal is obtained.

In some examples, after the plurality of interface sub-signals are obtained, the method further includes: the plurality of interface sub-signals are spliced in a generation order of the plurality of interface sub-signals, and the interface signal is obtained.

In an illustrative example, the method further includes: output of the second interface is initialized to a low level before the control step. Since a default level state is low level according to a transmission protocol specification of the predetermined interface protocol, in the example, the output of the second interface is initialized to the low level. When the first timer and the second timer are turned on, the output is set higher through the second interface to output the first signal in a high level.

In order to further implement simulation of the interface signal of the first interface by software and further avoid upgrading an architecture of the BMC chip or investing hardware, in yet another optional embodiment, the control step includes: controlling the first timer and the second timer to start timing; setting an output signal of the second interface to a high level, and outputting the first signal at the high level through the second interface; and in a case that the timing duration of the first timer reaches the first duration, stopping outputting the first signal and setting an output signal of the second interface to a low level.

In some examples, in a case that the timing duration of the first timer reaches the first duration, the stopping outputting the first signal includes: triggering a first interruption in the case that the timing duration of the first timer reaches the first duration to stop outputting the first signal. By triggering the first interruption, the first timer is turned off to control the duration of the high level in the interface sub-signal, further implementing conversion of different logic bits.

In some examples, the first interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the first interruption and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

In order to further implement simulation of the interface signal of the first interface by software and further avoid upgrading an architecture of the BMC chip or investing hardware, according to yet another illustrative example, the output step includes: in a case that the timing duration of the first timer reaches the first duration, setting an output signal of the second interface to a low level, and outputting the second signal in the low level through the second interface; and in a case that the timing duration of the second timer reaches the second duration, stopping outputting the second signal, and setting an output signal of the second interface to a high level to obtain the interface sub-signal.

In some examples, in a case that the timing duration of the second timer reaches the second duration, the stopping outputting the second signal includes: triggering a second interruption in the case that the timing duration of the second timer reaches the second duration to stop outputting the second signal. By triggering the second interruption, the second timer is turned off to control the duration of the interface sub-signal, and it is further guaranteed that each interface sub-signal with the same duration can be obtained more accurately.

In some examples, each time the second interruption is triggered, timing counting is performed once. The timing counting represents the number of logic bits that have completed conversion.

Further, the second interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the second interruption and in the order of the logic bits. The kernel partition may also determine the position of the logic bit to be currently subjected to signal conversion by the timing counting and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

During application, a person skilled in the art may flexibly set a structure form of the control instruction. In an optional solution, a data structure of the control instruction includes an address rate field, a target address field, a message rate field, a write length field and a read length field, wherein the address rate field represents a transmission rate of address data, the target address field represents address data of the hardware partition, and the message rate field represents a transmission rate of message data. The write length field represents write operation information of the kernel partition. The read length field represents read operation information of the kernel partition.

For example, when the control instruction is the first instruction used for determining whether the hardware partition exists, a message transmission format of the first instruction is as shown in FIG. 4. The address rate field is two logic bits 0, and the message rate field is one logic bit 0. The target address field, the write length field and the read length field are all 8 logical bits. The target address field is determined by the hardware design of the hardware partition and is typically 0x30 (0x represents a hexadecimal number). The write length field and the read length field are both 0x00. The above fields are all completed by a write operation initiated by the kernel partition.

Further, after the transmitting the interface signal to the first interface through a second interface, the method further includes: receiving a response instruction generated by the hardware partition in response to the control instruction, wherein the response instruction comprises the control instruction and a frame check field (frame check sequence, FCS). The response instruction generated by the hardware partition in response to the control instruction includes not only information of the control instruction, but also a frame check field located at a tail of the control instruction. Information recognizable by the second interface is obtained through conversion, and the field format shown in FIG. 4 is obtained.

In an illustrative example, the first interface comprises a platform environment control interface (PECI), and the second interface comprises a general-purpose input/output (GPIO) interface. That is to say, the kernel partition of the present application simulates a PECI signal through the GPIO interface, and transmits the PECI signal to the PECI of the hardware partition through the GPIO interface. Thus expansion of a PECI link between the BMC and the host system. Then an effect of independently managing the hardware partitions of the host system of the server through the kernel partitions of the BMC without performing hardware logic design on the BMC chip is further achieved. An ability of one BMC chip to independently monitor the plurality of hardware partitions of the host system is further achieved.

In some examples, the first interface is a PECI, and the second interface is a GPIO interface. The PECI is an interface for information exchange between the BMC and a processor of the host system. The PECI is an important interface in the server, and is mainly responsible for obtaining a CPU temperature, power consumption and failure state information of key unit modules such as a CPU, an ultra path interconnect (UPI) link, a memory controller, and a peripheral component interconnect express (PCIe) link, and provide a powerful guarantee for health status monitoring, fault analysis and positioning of a server system. The BMC has a plurality of GPIO interfaces, such that no additional hardware overhead is introduced when the technical solution of the present application is implemented.

In order to further implement expansion of a communication link between the BMC chip and the host system, and further achieve an effect that one BMC chip monitors a plurality of hardware partitions of the host system, according to some other examples, the quantity of the hardware partition in the host system is more than one, the quantity of the kernel partition in the BMC is more than one, one kernel partition of more than one kernel partitions comprises a third interface, the other kernel partitions, excluding the one kernel partition, of the more than one kernel partitions each comprises the second interface, each of more than one hardware partitions comprises the first interface, an interface type of the third interface is identical to an interface type of the first interface, and the method further includes: transmitting the control instruction to the corresponding first interface through the third interface. In the examples, one of the kernel partitions is connected to the first interface of one hardware partition through the third interface, and other kernel partitions are connected to the first interfaces of other hardware partitions through the second interfaces in a one-to-one corresponding manner. That is to say, the kernel partitions of the BMC monitor the hardware partitions in a one-to-one corresponding manner through a physical link formed by the third interface and the first interface, or through physical links formed by the second interfaces and the first interfaces. Thus one BMC management unit independently manages the plurality of hardware partitions, and independence of fault management functions of different partition systems of a unified server platform is further guaranteed.

In some examples, the third interface is also a PECI. In the related art, one BMC chip only has one PECI, that is, only one PECI link can be established with the host system through the PECI. According to the solution of the present application, besides the PECI link is retained, a PECI protocol is simulated through the plurality of GPIO interfaces of the BMC chip, such that one-to-one corresponding PECI links are established with PECIs of other hardware partitions of the host system through the GPIO interfaces. Expansion of the PECI links is implemented. The kernel partitions of the BMC can monitor the hardware partitions one to one.

In an actual application process, a first operating system is deployed on the hardware partitions, and a second operating system is deployed on the kernel partitions. The first operating system includes, but is not limited to, a Linux system, a real time operating system (RTOS), or another self-developed software system. The second operating system includes, but is not limited to, a Linux system, an RTOS, or another self-developed software system.

Moreover, in the present application, the BMC is divided into a plurality of kernel partitions according to a kernel, and one of second operating system is deployed in one kernel partition. The kernel partitions correspond to the hardware partitions one to one, that is, one kernel partition performs health state monitoring, remote switching, temperature (voltage) collection, fault analysis and positioning, etc. on one hardware partition.

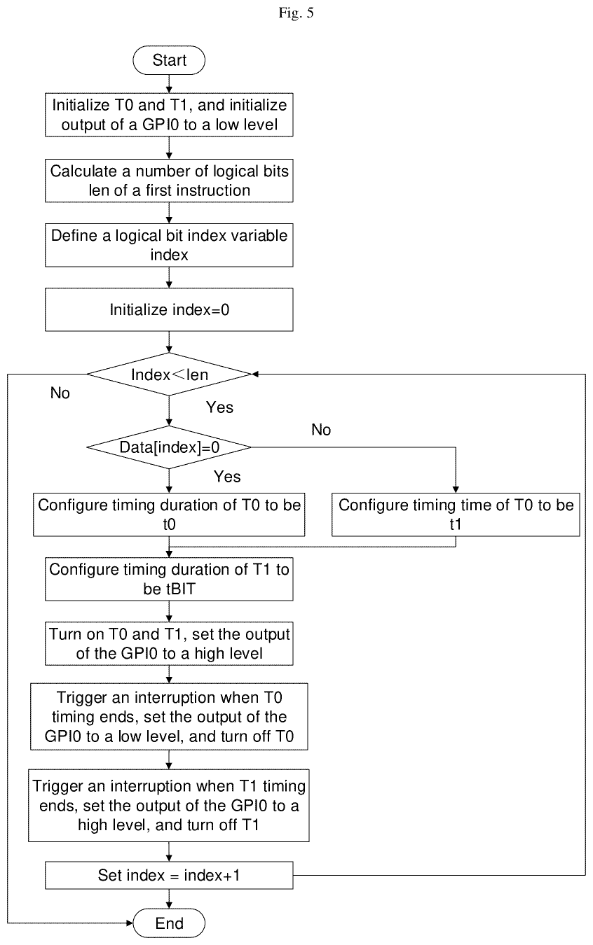

In order to cause a person skilled in the art to understand an interface signal generation process in the present application more clearly, the following description will be made by taking a PECI as the first interface, a GPIO interface as the second interface, and the first instruction to determine whether the hardware partition exists as the control instruction as an example in conjunction with FIG. 5.

According to PECI-related protocols, the PECIs are divided into Host (host system) devices and Client (guest) devices. Each communication is initiated by a Host device. The Host device obtains corresponding information through different PECI commands. In the present application, one kernel partition of BMC is used as the Host device, and a hardware partition corresponding to the kernel partition in the host system is used as the Client device.

A message transmission format of the first instruction, that needs to be transmitted by the kernel partition, of the kernel partition is shown in FIG. 4, and a corresponding data stream is 00 00100000 0 00000000 00000000, with a total of 27 logical bits, that is, the length of the data stream is 27. A waveform definition of logic bits 0 and 1 in the PECI protocol is shown in FIG. 3. In FIG. 3, tBIT represents a period of one bit (logic bit=0 or 1). Logic bit 0 and logic bit 1 are distinguished by a duty ratio of a high level in the entire tBIT. That is, high level time of logic bit 0 is 0.2 tBIT to 0.4 tBIT, and is represented by t0; and high level time of logic bit 1 is 0.6 tBIT to 0.8 tBIT, and is represented by t1. In software design of the present application, t0 (or t1) is timed by the first timer T0, tBIT is timed by the second timer T1, and an interface signal generation process is as follows:
S1: the first timer T0 and the second timer T1 are initialized, a GPIO controller is initialized, and output of the second interface GPIO is configured to be in a low level;
S2: a data stream of a first instruction is cached into a char array variable, and a number of logic bits of the data stream is calculated and is stored into a variable len to obtain len=27;
S3: an index variable index of the logic bits is initialized and is set to 0;
S4: whether index is less than len is determined, if yes, S5 is performed, and otherwise, the entire flow ends;
S5: whether logic bit Data [index] corresponding to index is equal to 0 is determined, if yes, timing time of the first timer T0 is configured to be to, and otherwise the timing time of the first timer T0 is configured to be t1;
S6: timing time of the second timer T1 is configured to be tBIT;
S7; when a TO interruption is triggered, the output of the second interface GPIO is set to a low level, and the first timer T0 is turned off;
S8: when a T1 interruption is triggered, the output of the second interface GPIO is set to a high level, and the second timer T1 is turned off; and
S9: index=index+1 is updated, and S4 is returned to.

In the above example, a GPIO simulation method based on two timers can implement the expansion and construction of the GPIO interfaces to PECI-type PECI independent links in the hardware partition systems, and implement an independent monitoring capability of a single BMC management unit to a multi-hardware partition system of the host system.

Through the description of embodiments, those skilled in the art can clearly understand that the method according to the above example may be implemented in combination of software and a necessary general-purpose hardware platform and may also be certainly implemented through hardware. However, the former is a preferred embodiment in many cases. Based on such understanding, the technical solution in essence of the present application or the part that contributes to the related art can be embodied in the form of software products. The computer software product is stored in a non-volatile readable storage medium (such as a read-only memory (ROM)/a random access memory (RAM), a magnetic disk, or an optical disk), and includes several instructions to make a terminal device (such as a mobile phone, a computer, a server, or a network device) execute the method in each example of the present application.

The example further provides an apparatus for interface communication. The apparatus is configured for implementing the example described above and optional embodiments, the repetitions of which will not be described in detail herein. As used below, the term “module” can be a combination of software and/or hardware that implements preset functions. While the apparatus described in the following example is preferably implemented through software, it is possible and conceivable that the apparatus is implemented through hardware, or a combination of the software and the hardware.

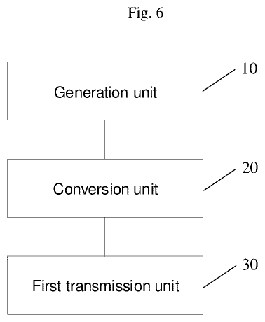

FIG. 6 is a block diagram of an apparatus for interface communication according to an example of the present application. A host system of a server comprises a hardware partition, a baseboard management controller (BMC) comprises a kernel partition, the kernel partition is configured to manage the hardware partition. The apparatus is applied to the kernel partition. As shown in FIG. 6, the apparatus includes:
a generation unit 10 configured to generate a control instruction for controlling the hardware partition.

In some examples, the control instruction includes at least one of the following: a first instruction configured to determine whether the hardware partition exists; a second instruction configured to obtain a sensor temperature of the hardware partition; and a third instruction configured to obtain register data of the hardware partition.

The apparatus further includes a conversion unit 20 configured to convert the control instruction into an interface signal conforming to a predetermined interface protocol, wherein the predetermined interface protocol is an interface protocol of a first interface of the hardware partition.

In some examples, the interface signal may be a platform environment control interface (PECI) signal or an interface signal of another protocol type.

The apparatus further includes a first transmission unit 30 configured to transmit the interface signal to the first interface through a second interface, wherein an interface type of the first interface is different from an interface type of the second interface.

In some examples, the first interface comprises a platform environment control interface (PECI), and the second interface comprises a general-purpose input/output (GPIO) interface.

Through the above solution, in the scenario of a hardware partition of the host system of the server, by means of the generation unit, the control instruction to control the hardware partition is firstly generated through the kernel partition of the BMC. By means of the conversion unit, the control instruction is converted to obtain the interface signal conforming to the interface protocol of the first interface of the hardware partition. By means of the first transmission unit, the obtained interface signal is transmitted to the first interface through the second interface, so as to control one hardware partition of the host system. Compared with the problems that a BMC chip needs to be provided with hardware logic design of a PECI controller in the scenario of the hardware partition of the host system in the related art, thereby causing complex design of the BMC chip, in the present application, the hardware logic design of the PECI controller does not need to be implemented on the BMC chip in advance, and the interface signal can be generated on the BMC chip only by simulating the interface protocol of the first interface through the second interface by the kernel partition. Accordingly, the technical effect of simulating and generating a hardware interface signal in a software mode is achieved, and then a purpose of hardware logic design without the chip itself having relevant hardware interface signals is further achieved. Not only design difficulty of the BMC chip can be reduced, design cost and a design cycle of the BMC chip can be reduced, and an effect that one kernel partition of the BMC independently manages one hardware partition in the host system can also be achieved. Thus expansion of a communication link between the BMC and the host system is implemented, and then a purpose that one BMC chip independently controls the plurality of hardware partitions of the host system can be achieved.

In an illustrative example, the conversion unit includes a determination module configured to determine a plurality of pieces of logic bit information corresponding to the control instruction according to the predetermined interface protocol; and a generation module configured to generate the interface signal according to the plurality of pieces of logic bit information, a first timer, and a second timer. In the example, the interface signal corresponding to the control instruction is generated according to the predetermined interface protocol, such that a technical effect of generating the interface signal of the first interface by simulation in a software mode is further achieved.

In order to generate the interface signal according to the plurality of pieces of logic bit information, a first timer, and a second timer, according to some optional examples of the present application, the generation module includes: a first determination sub-module configured to determine timing duration of the first timer and timing duration of the second timer according to the plurality of pieces of logic bit information; and a generation sub-module configured to generate the interface signal through the second interface according to the timing duration of the first timer and the timing duration of the second timer.

In some examples, the first timer and the second timer may be a timer program in the kernel partition or a register on the kernel partition. The first timer and the second timer may at least provide a timing function.

In another illustrative example, the first determination sub-module is further configured to obtain first duration and second duration corresponding to each piece of logic bit information in the plurality of pieces of logic bit information, wherein the first duration represents duration in which the each piece of logic bit information is at a high level, the second duration represents total duration of the each piece of logic bit information, and the first duration corresponding to different pieces of logic bit information in the plurality of pieces of logic bit information is different. The first determination sub-module is further configured to determine that the timing duration of the first timer is the first duration, and determining that the timing duration of the second timer is the second duration. In the example, by setting the timing duration of the first timer to be the first duration and the timing duration of the second timer to be the second duration, it is convenient to generate the logic bit information corresponding to different logic bits according to the timing duration of the first timer and the second timer subsequently, and then to obtain the interface signal. The purpose of generating the interface signal by using a software system on the basis of not requiring hardware logic design of the interface signal for the BMC chip is further achieved. Thus the design difficulty of the BMC chip is further reduced.

The first duration is shorter than the second duration.

In some examples, the control instruction is composed of at least one field. The field is represented by a plurality of logic bits. Each logic bit may be 0 or 1. Each logic bit is converted into the corresponding logic bit information, that is, the interface signal corresponding to the control instruction is obtained. The logic bit information may be represented by a combination of a high level signal and a low level signal. For example, logic bit 0 may be represented by a combination of a high level signal of first preset duration and a low level signal of second preset duration, and logic bit 1 may be represented by a combination of a high level signal of third preset duration and a low level signal of fourth preset duration. The first preset duration is different from the third preset duration, and the second preset duration is different the fourth preset duration.

Generally speaking, under an interface protocol, running duration corresponding to each piece of logic bit information in the plurality of pieces of logic bit information is the same, that is, the second duration corresponding to each piece of logic bit information is the same. Thus a sum of the first preset duration and the second preset duration is equal to a sum of the third preset duration and the fourth preset duration.

In an actual application process, an order exists among the plurality of pieces of logic bit information. In order to further guarantee that the interface signal corresponding to the control instruction is obtained more accurately, in yet another optional example of the present application, the generation sub-module is further configured to sequentially generate, by the second interface, an interface sub-signal corresponding to each piece of logic bit information in the plurality of pieces of logic bit information in an order of the plurality of pieces of logic bit information according to the first duration of the first timer and the second duration of the second timer, to obtain the interface signal.

In some examples, the interface sub-signal is actually a waveform signal composed of a high level signal and a low level signal. A plurality of waveform signals form the interface signal.

In some examples, as shown in FIG. 3, when the logic bit is 0, the first duration corresponding to the first timer is t0. When the logic bit is 1, the first duration corresponding to the first timer is t1, and t0 is less than t1. The second duration is tBIT. Generally, t0 is 0.6 time to 0.8 time tBIT, that is, t0=0.2 tBIT to 0.4 tBIT, and t1 is 0.6 time to 0.8 time tBIT, that is, t1=0.6 tBIT to 0.8 tBIT.

In an illustrative example, the generation sub-module is further used for performing:
a control step: controlling the first timer and the second timer to start timing, and outputting a first signal through the second interface before the timing duration of the first timer reaches the first duration.

In some examples, the first timer and the second timer each include a down counter. An initial value of the first timer is set to the first duration. An initial value of the second timer is set to the second duration. When the first timer and the second timer start timing, the down counters start to decrease from the initial value to 0, and trigger interruptions of the first timer and the second timer when reaching 0. The initial value of the first timer is reset to the first duration. The initial value of the second timer is reset to the second duration. Then countdown is performed again. The interruption may be understood as an identifier, and thus the interruption may also be referred to as an interruption identifier.

In some examples, the first signal is a high level signal. In the present application, in order to convert logic bit 0 or 1 into a corresponding interface sub-signal, the first signal in a high level is generated through the second interface before the timing duration of the first timer reaches the first duration.

The generation sub-module is further used for performing an output step: outputting a second signal through the second interface after the timing duration of the first timer reaches the first duration and before the timing duration of the second timer reaches the second duration, to obtain the interface sub-signal composed of the first signal and the second signal.

In some examples, the second signal is a low level signal. In the present application, in order to distinguish between logic bits 0 and 1, after the timing duration of the first timer reaches the first duration, the second signal in a low level is generated through the second interface. Until the timing duration of the second timer reaches the second duration, interface sub-signals of different waveforms are obtained. Waveform signals corresponding to the logic bits 0 and 1 have different duty ratios.

The generation sub-module is further used for performing a count step: performing a timing counting operation in a case that the timing duration of the second timer reaches the second duration.

In some examples, the timing counting may be performed once as follows: one is added to an original timing counting value.

The generation sub-module is further used for performing a determination step: determining whether a timing counting value obtained from the timing counting operation is less than a total number of the plurality of pieces of the logic bit information; in a case that the timing counting value is less than the total number of the plurality of pieces of logic bit information, sequentially performing the control step, the output step, and the count step in the order until the timing counting value is not less than the total number of the plurality of pieces of logic bit information, to obtain the interface signal comprising a plurality of interface sub-signals.

In the above example, the first timer and the second timer are configured in the order of the logic bits and controlled to start. The first signal and the second signal corresponding to the timing duration of the first timer and the second timer are output according to the timing duration of the first timer and the second timer. Thus the duration of the waveform signals corresponding to the logic bits are controlled, and the effect of sequentially simulating the plurality of interface sub-signals in a software manner to obtain the interface signal is further achieved.

The apparatus further includes: a first initialization unit configured to initialize the timing counting value to 0 before the control step.

In an actual application process, the apparatus further includes: a storage unit configured to store, before the plurality of pieces of logic bit information corresponding to the control instruction are determined according to the predetermined interface protocol, the control instruction composed of the plurality of logic bits into an array variable, where a data stream length of the array variable is greater than or equal to a number of the logic bits, and each logic bit is stored in the array variable in a sorting order; and a setting unit configured to set an index variable of the logic bits, where the index variable is used for indexing the logic bits corresponding to positions from the array variable. In this way, in a subsequent process of determining the plurality of pieces of logic bit information corresponding to the control instruction according to the predetermined interface protocol, the logic bits may be sequentially read from the array variable in the order of the logic bits, and the corresponding logic bit information may be determined.

Then, the determination module includes: an indexing sub-module configured to perform an indexing step: a logic bit to be converted is obtained from the array variable according to the index variable; and a second determination sub-module configured to perform a second determination step: logic bit information corresponding to the logic bit to be converted is determined according to the predetermined interface protocol.

The apparatus further includes a second initialization unit configured to initialize the index variable to 0 after the index variable of the logic bit is set and before the logic bit to be converted is obtained from the array variable according to the index variable.

In the above example, a step that the first duration and the second duration corresponding to each piece of logic bit information are obtained is taken as an obtaining step. Steps that the first duration is determined as the timing duration of the first timer, and the second duration is determined as the timing duration of the second timer are taken as a fourth determination step. A step that the interface sub-signal corresponding to each piece of logic bit information is sequentially generated through the second interface in the order of the plurality of pieces of logic bit information according to the first duration of the first timer and the second duration of the second timer is taken as a generation step. The apparatus may further include an accumulation unit configured to perform an accumulation step: one is added to the index variable to obtain an updated index variable when the timing duration of the second timer reaches the second duration. The apparatus further includes: a determination unit configured to perform a third determination step: whether the updated index variable is less than the total number of the logical bits is determined, in a case that the updated index variable is less than the total number of the logical bits, the indexing step, the second determination step, the obtaining step, the fourth determination step, and the generation step are sequentially performed until the index variable is not less than the number of the logical bits. That is to say, the logic bits are sequentially read from the array variable through the index variable. The first duration and the second duration corresponding to a read logic bit are obtained, the timing duration of the first timer and the second timer is obtained. Finally the first timer and the second timer are controlled to start timing according to the timing duration. The interface sub-signals corresponding to the logic bit information are sequentially generated through the second interface. The interface sub-signals are further generated in order. Thus a more accurate interface signal can be obtained.

The order of the logic bits refers to the order of logic bits constituting the control instruction. In a case that the logic bits corresponding to the control instruction include logic bit 1, logic bit 2, logic bit 3, . . . , and logic bit n in order, and corresponding index variables include index variable 0, index variable 1, index variable 2, . . . , and index variable n−1, interface sub-signals corresponding to logic bit 1, logic bit 2, logic bit 3, . . . , and logic bit n are sequentially generated through a loop process, that is, interface sub-signal 1, interface sub-signal 2, interface sub-signal 3, . . . , and interface sub-signal n are obtained, and the interface signal is obtained.

In some examples, the apparatus further includes a splicing unit configured to splice, after the plurality of interface sub-signals are obtained, the plurality of interface sub-signals are in a generation order of the plurality of interface sub-signals, and obtain the interface signal.

In an illustrative example, the apparatus further includes a third initialization unit configured to initialize an output signal of the second interface to a low level before the control step. Since a default level state is low level according to a transmission protocol specification of the predetermined interface protocol, in the example, the output of the second interface is initialized to the low level. When the first timer and the second timer are turned on, the output is set higher through the second interface to output the first signal in a high level.

In order to further implement simulation of the interface signal of the first interface by software and further avoid upgrading an architecture of the BMC chip or investing hardware, in yet another optional embodiment, the generation sub-module is further configured to control the first timer and the second timer to start timing; the generation sub-module is further configured to set an output signal of the second interface to a high level, and outputting the first signal at the high level through the second interface; and the generation sub-module is further configured in a case that the timing duration of the first timer reaches the first duration, stop outputting the first signal and setting an output signal of the second interface to a low level.

In some examples, the generation sub-module is further configured to trigger a first interruption in the case that the timing duration of the first timer reaches the first duration to stop outputting the first signal. By triggering the first interruption, the first timer is turned off to control the duration of the high level in the interface sub-signal, further implementing conversion of different logic bits.

In some examples, the first interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the first interruption and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

In order to further implement simulation of the interface signal of the first interface by software and further avoid upgrading an architecture of the BMC chip or investing hardware, according to yet another illustrative example, the generation sub-module is further configured to in a case that the timing duration of the first timer reaches the first duration, set an output signal of the second interface to a low level, and outputting the second signal in the low level through the second interface; and the generation sub-module is further configured to in a case that the timing duration of the second timer reaches the second duration, stop outputting the second signal, and setting an output signal of the second interface to a high level to obtain the interface sub-signal.

In some examples, the generation sub-module is further configured to trigger a second interruption in the case that the timing duration of the second timer reaches the second duration to stop outputting the second signal. By triggering the second interruption, the second timer is turned off to control the duration of the interface sub-signal, and it is further guaranteed that each interface sub-signal with the same duration can be obtained more accurately.

In some examples, each time the second interruption is triggered, timing counting is performed once. The timing counting represents the number of logic bits that have completed conversion.

Further, the second interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the second interruption and in the order of the logic bits. The kernel partition may also determine the position of the logic bit to be currently subjected to signal conversion by the timing counting and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

During application, a person skilled in the art may flexibly set a structure form of the control instruction. In an optional solution, a data structure of the control instruction includes an address rate field, a target address field, a message rate field, a write length field and a read length field, wherein the address rate field represents a transmission rate of address data, the target address field represents address data of the hardware partition, and the message rate field represents a transmission rate of message data. The write length field represents write operation information of the kernel partition. The read length field represents read operation information of the kernel partition.

For example, when the control instruction is the first instruction used for determining whether the hardware partition exists, a message transmission format of the first instruction is as shown in FIG. 4. The address rate field is two logic bits 0, and the message rate field is one logic bit 0. The target address field, the write length field and the read length field are all 8 logical bits. The target address field is determined by the hardware design of the hardware partition and is typically 0x30 (0x represents a hexadecimal number). The write length field and the read length field are both 0x00. The above fields are all completed by a write operation initiated by the kernel partition.

Further, the apparatus further includes a reception unit configured to receive, after the transmitting the interface signal to the first interface through a second interface, a response instruction generated by the hardware partition in response to the control instruction, wherein the response instruction comprises the control instruction and a frame check field. The response instruction generated by the hardware partition in response to the control instruction includes not only information of the control instruction, but also a frame check field located at a tail of the control instruction. Information recognizable by the second interface is obtained through conversion, and the field format shown in FIG. 4 is obtained.

In an illustrative example, the first interface comprises a platform environment control interface (PECI), and the second interface comprises a general-purpose input/output (GPIO) interface. That is to say, the kernel partition of the present application simulates a PECI signal through the GPIO interface, and transmits the PECI signal to the PECI of the hardware partition through the GPIO interface. Thus expansion of a PECI link between the BMC and the host system. Then an effect of independently managing the hardware partitions of the host system of the server through the kernel partitions of the BMC without performing hardware logic design on the BMC chip is further achieved. An ability of one BMC chip to independently monitor the plurality of hardware partitions of the host system is further achieved.

In some examples, the first interface comprises a platform environment control interface (PECI), and the second interface comprises a general-purpose input/output (GPIO) interface. The PECI is an interface for information exchange between the BMC and a processor of the host system. The PECI is an important interface in the server, and is mainly responsible for obtaining a CPU temperature, power consumption and failure state information of key unit modules such as a CPU, a UPI link, a memory controller, and a PCIe link, and provide a powerful guarantee for health status monitoring, fault analysis and positioning of a server system. The BMC has a plurality of GPIO interfaces, such that no additional hardware overhead is introduced when the technical solution of the present application is implemented.

In order to further implement expansion of a communication link between the BMC chip and the host system, and further achieve an effect that one BMC chip monitors a plurality of hardware partitions of the host system, according to some other examples, the quantity of the hardware partition in the host system is more than one, the quantity of the kernel partition in the BMC is more than one, one kernel partition of more than one kernel partitions comprises a third interface, the other kernel partitions, excluding the one kernel partition, of the more than one kernel partitions each comprises the second interface, each of more than one hardware partitions comprises the first interface, an interface type of the third interface is identical to an interface type of the first interface. The apparatus further includes a second transmission unit configured to transmit the control instruction to the corresponding first interface through the third interface. In the examples, one of the kernel partitions is connected to the first interface of one hardware partition through the third interface, and other kernel partitions are connected to the first interfaces of other hardware partitions through the second interfaces in a one-to-one corresponding manner. That is to say, the kernel partitions of the BMC monitor the hardware partitions in a one-to-one corresponding manner through a physical link formed by the third interface and the first interface, or through physical links formed by the second interfaces and the first interfaces. Thus one BMC management unit independently manages the plurality of hardware partitions, and independence of fault management functions of different partition systems of a unified server platform is further guaranteed.

In some examples, the third interface is also a PECI. In the related art, one BMC chip only has one PECI, that is, only one PECI link can be established with the host system through the PECI. According to the solution of the present application, besides the PECI link is retained, a PECI protocol is simulated through the plurality of GPIO interfaces of the BMC chip, such that one-to-one corresponding PECI links are established with PECIs of other hardware partitions of the host system through the GPIO interfaces. Expansion of the PECI links is implemented. The kernel partitions of the BMC can monitor the hardware partitions one to one.

In an actual application process, a first operating system is deployed on the hardware partitions, and a second operating system is deployed on the kernel partitions. The first operating system includes, but is not limited to, a Linux system, a RTOS, or another self-developed software system. The second operating system includes, but is not limited to, a Linux system, an RTOS, or another self-developed software system.

Moreover, in the present application, the BMC is divided into a plurality of kernel partitions according to a kernel, and one of second operating system is deployed in one kernel partition. The kernel partitions correspond to the hardware partitions one to one, that is, one kernel partition performs health state monitoring, remote switching, temperature (voltage) collection, fault analysis and positioning, etc. on one hardware partition.

It should be noted that each module described above can be implemented through software or hardware. The latter can be implemented in, but not limited to, the following manners: the above modules are positioned in the same processor; and alternatively, the above modules are positioned in different processors in any combination.

The examples of the present application further provide a non-volatile readable storage medium. The non-volatile readable storage medium stores a computer program. The computer program is configured to execute steps of any one of the above method examples when run.

In an illustrative example, the non-volatile readable storage medium may include, but is not limited to, various media storing a computer program, such as a universal serial bus (USB) flash disk, a read-only memory (ROM), a random access memory (RAM), a mobile hard disk, a magnetic disk or an optical disk, etc.

The examples of the present application further provide an electronic device. The electronic device includes a memory and a processor, where the memory stores a computer program, and the processor is configured to execute steps of any one of the above method examples when running the computer program.

In an illustrative example, the electronic device may further include a transmission device and an input/output device, where the transmission device and the input/output device are connected to the processor.

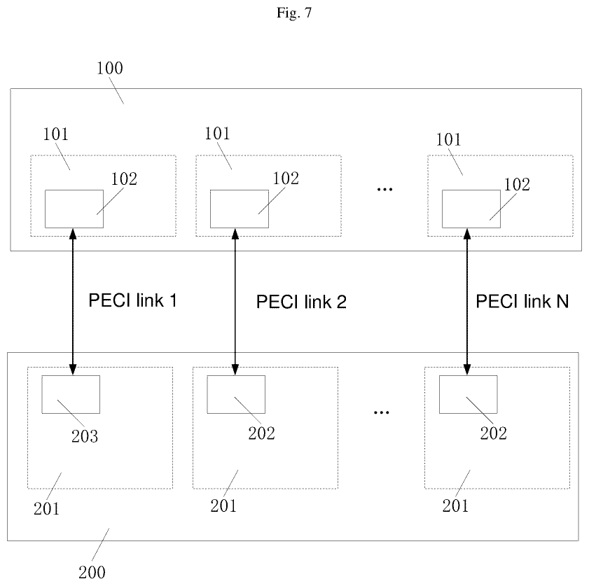

The examples of the present application further provide a server as shown in FIG. 7. The server includes: a host system 100 including a plurality of hardware partitions 101, where each of the plurality of hardware partitions include a first interface 102; and a BMC 200 including a plurality of kernel partitions 201, where the plurality of kernel partitions 201 correspond one-to-one with the plurality of hardware partitions 101, at least part of the plurality of kernel partitions each comprise a second interface 202, and an interface type of the first interfaces 102 is different from an interface type of the second interface 202. Each of at least part of the plurality of kernel partitions 201 is configured to generate a control instruction to control a corresponding hardware partition 101 in the plurality of hardware partitions; convert the control instruction into an interface signal conforming to a predetermined interface protocol, wherein the predetermined interface protocol is an interface protocol of the first interface 102 of each of the plurality of the hardware partitions 101; and transmit the interface signal to the first interface 102 through the second interfaces 202.

In the above server, the host system is divided into the plurality of independent hardware partitions. The BMC is divided into the plurality of independent kernel partitions. The kernel partitions correspond to the hardware partitions one to one. The kernel partitions are connected to the first interfaces of the corresponding hardware partitions through the second interfaces. The kernel partitions simulate the interface protocols of the first interfaces through the second interfaces to monitor the hardware partitions. In this way, according to the present application, hardware logic design of a PECI controller does not need to be implemented on a BMC chip in advance, and the interface signal can be generated on the BMC chip only by simulating the interface protocol of the first interface through the second interface by the kernel partition. Accordingly, the technical effect of simulating and generating a hardware interface signal in a software mode is achieved, and then a purpose of hardware logic design without the chip itself having relevant hardware interface signals is further achieved. Not only design difficulty of the BMC chip can be reduced, design cost and a design cycle of the BMC chip can be reduced, and an effect that one kernel partition of the BMC independently manages one hardware partition in the host system can also be achieved. Thus expansion of a communication link between the BMC and the host system is implemented, and then a purpose that one BMC chip independently controls the plurality of hardware partitions of the host system can be achieved.

Moreover, in the present application, the host system is divided into the plurality of hardware partitions according to a number of CPU units. One hardware partition includes one CPU unit, and one first operating system is correspondingly deployed. The BMC is divided into the plurality of kernel partitions according to the number of kernels, and one second operating system is deployed in one kernel partition. The kernel partitions correspond to the hardware partitions one to one, that is, one kernel partition performs health state monitoring, remote switching, temperature (voltage) collection, fault analysis and positioning, etc. on one hardware partition.

In an illustrative example, each of at least part of the plurality of kernel partitions is further configured to determine a plurality of pieces of logic bit information corresponding to the control instruction according to the predetermined interface protocol, and generate the interface signal according to the plurality of pieces of logic bit information, a first timer and a second timer. In the example, the interface signal corresponding to the control instruction is generated according to the predetermined interface protocol, such that a technical effect of generating the interface signal of the first interface by simulation in a software mode is further achieved.

In order to generate the interface signal corresponding to the control instruction according to the plurality of pieces of logic bit information, the first timer and the second timer, according to some optional examples of the present application, each of at least part of the plurality of kernel partitions is further configured to determine timing duration of the first timer and timing duration of the second timer according to the plurality of pieces of logic bit information, and generate the interface signal through the second interface according to the timing duration of the first timer and the timing duration of the second timer.

In some examples, the first timer and the second timer may be a timer program in the kernel partition or a register on the kernel partition. The first timer and the second timer may at least provide a timing function.

In another illustrative example, each of at least part of the plurality of kernel partitions is further configured to obtain first duration and second duration corresponding to each piece of logic bit information in the plurality of pieces of logic bit information, wherein the first duration represents duration in which the each piece of logic bit information is at a high level, the second duration represents total duration of the each piece of logic bit information, and the first duration corresponding to different pieces of logic bit information in the plurality of pieces of logic bit information is different; and determine that the timing duration of the first timer is the first duration, and determine that the timing duration of the second timer is the second duration. In the example, by setting the timing duration of the first timer to be the first duration and the timing duration of the second timer to be the second duration, it is convenient to generate the logic bit information corresponding to different logic bits according to the timing duration of the first timer and the second timer subsequently, and then to obtain the interface signal. The purpose of generating the interface signal by using a software system on the basis of not requiring hardware logic design of the interface signal for the BMC chip is further achieved. Thus the design difficulty of the BMC chip is further reduced.

The first duration is shorter than the second duration.

In some examples, the control instruction is composed of at least one field. The field is represented by a plurality of logic bits. Each logic bit may be 0 or 1. Each logic bit is converted into the corresponding logic bit information, that is, the interface signal corresponding to the control instruction is obtained. The logic bit information may be represented by a combination of a high level signal and a low level signal. For example, logic bit 0 may be represented by a combination of a high level signal of first preset duration and a low level signal of second preset duration, and logic bit 1 may be represented by a combination of a high level signal of third preset duration and a low level signal of fourth preset duration. The first preset duration is different from the third preset duration, and the second preset duration is different the fourth preset duration.

Generally speaking, under an interface protocol, running duration corresponding to each piece of logic bit information in the plurality of pieces of logic bit information is the same, that is, the second duration corresponding to each piece of logic bit information is the same. Thus a sum of the first preset duration and the second preset duration is equal to a sum of the third preset duration and the fourth preset duration.

In an actual application process, an order exists among the plurality of pieces of logic bit information. In order to further guarantee that the interface signal corresponding to the control instruction is obtained more accurately, in yet another optional example of the present application, each of at least part of the plurality of kernel partitions is further configured to sequentially generate, by the second interface, an interface sub-signal corresponding to each piece of logic bit information in the plurality of pieces of logic bit information through the second interface in an order of the plurality of pieces of logic bit information according to the first duration of the first timer and the second duration of the second timer, to obtain the interface signal.

In some examples, the interface sub-signal is actually a waveform signal composed of a high level signal and a low level signal. A plurality of waveform signals form the interface signal.

In some examples, as shown in FIG. 3, when the logic bit is 0, the first duration corresponding to the first timer is t0. When the logic bit is 1, the first duration corresponding to the first timer is t1, and to is less than t1. The second duration is tBIT. Generally, t0 is 0.6 time to 0.8 time tBIT, that is, t0=0.2 tBIT to 0.4 tBIT, and t1 is 0.6 time to 0.8 time tBIT, that is, t1=0.6 tBIT to 0.8 tBIT.

In an illustrative example, the kernel partition is further used for:
a control step: controlling the first timer and the second timer to start timing, and outputting a first signal through the second interface before the timing duration of the first timer reaches the first duration.

In some examples, the first timer and the second timer each include a down counter. An initial value of the first timer is set to the first duration. An initial value of the second timer is set to the second duration. When the first timer and the second timer start timing, the down counters start to decrease from the initial value to 0, and trigger interruptions of the first timer and the second timer when reaching 0. The initial value of the first timer is reset to the first duration. The initial value of the second timer is reset to the second duration. Then countdown is performed again. The interruption may be understood as an identifier, and thus the interruption may also be referred to as an interruption identifier.

In some examples, the first signal is a high level signal. In the present application, in order to convert logic bit 0 or 1 into a corresponding interface sub-signal, the first signal in a high level is generated through the second interface before the timing duration of the first timer reaches the first duration.

The kernel partition is further used for an output step: outputting a second signal through the second interface after the timing duration of the first timer reaches the first duration and before the timing duration of the second timer reaches the second duration, to obtain the interface sub-signal composed of the first signal and the second signal.

In some examples, the second signal is a low level signal. In the present application, in order to distinguish between logic bits 0 and 1, after the timing duration of the first timer reaches the first duration, the second signal in a low level is generated through the second interface. Until the timing duration of the second timer reaches the second duration, interface sub-signals of different waveforms are obtained. Waveform signals corresponding to the logic bits 0 and 1 have different duty ratios.

The kernel partition is further used for a count step: performing a timing counting operation in a case that the timing duration of the second timer reaches the second duration.

In some examples, the timing counting may be performed once as follows: one is added to an original timing counting value.

The kernel partition is further used for a determination step: determining whether a timing counting value obtained from the timing counting operation is less than a total number of the plurality of pieces of the logic bit information; in a case that the timing counting value is less than the total number of the plurality of pieces of logic bit information, sequentially performing the control step, the output step, and the count step in the order until the timing counting value is not less than the total number of the plurality of pieces of logic bit information, to obtain the interface signal comprising a plurality of interface sub-signals.

In the above example, the first timer and the second timer are configured in the order of the logic bits and controlled to start. The first signal and the second signal corresponding to the timing duration of the first timer and the second timer are output according to the timing duration of the first timer and the second timer. Thus the duration of the waveform signals corresponding to the logic bits are controlled, and the effect of sequentially simulating the plurality of interface sub-signals in a software manner to obtain the interface signal is further achieved.

The kernel partition is further used for initializing the timing counting value to 0 before the control step.

In an actual application process, the kernel partition is further used for storing, before the plurality of pieces of logic bit information corresponding to the control instruction are determined according to the predetermined interface protocol, the control instruction composed of the plurality of logic bits into an array variable, where a data stream length of the array variable is greater than or equal to a number of the logic bits, and each logic bit is stored in the array variable in a sorting order; and setting an index variable of the logic bits, where the index variable is used for indexing the logic bits corresponding to positions from the array variable. In this way, in a subsequent process of determining the plurality of pieces of logic bit information corresponding to the control instruction according to the predetermined interface protocol, the logic bits may be sequentially read from the array variable in the order of the logic bits, and the corresponding logic bit information may be determined.

Then, the kernel partition is further used for performing an indexing step: a logic bit to be converted is obtained from the array variable according to the index variable; and a second determination step: logic bit information corresponding to the logic bit to be converted is determined according to the predetermined interface protocol.

The kernel partition is further used for initializing the index variable to 0 after the index variable of the logic bit is set and before the logic bit to be converted is obtained from the array variable according to the index variable.

In the above example, a step that the first duration and the second duration corresponding to each piece of logic bit information are obtained is taken as an obtaining step. Steps that the first duration is determined as the timing duration of the first timer, and the second duration is determined as the timing duration of the second timer are taken as a fourth determination step. A step that the interface sub-signal corresponding to each piece of logic bit information is sequentially generated through the second interface in the order of the plurality of pieces of logic bit information according to the first duration of the first timer and the second duration of the second timer is taken as a generation step. The kernel partition is further used for an accumulation step: one is added to the index variable to obtain an updated index variable when the timing duration of the second timer reaches the second duration. The kernel partition is further used for a third determination step: whether the updated index variable is less than the total number of the logical bits is determined, in a case that the updated index variable is less than the total number of the logical bits, the indexing step, the second determination step, the obtaining step, the fourth determination step, and the generation step are sequentially performed until the index variable is not less than the number of the logical bits. That is to say, the logic bits are sequentially read from the array variable through the index variable. The first duration and the second duration corresponding to a read logic bit are obtained, the timing duration of the first timer and the second timer is obtained. Finally the first timer and the second timer are controlled to start timing according to the timing duration. The interface sub-signals corresponding to the logic bit information are sequentially generated through the second interface. The interface sub-signals are further generated in order. Thus a more accurate interface signal can be obtained.

The order of the logic bits refers to the order of logic bits constituting the control instruction. In a case that the logic bits corresponding to the control instruction include logic bit 1, logic bit 2, logic bit 3, . . . , and logic bit n in order, and corresponding index variables include index variable 0, index variable 1, index variable 2, . . . , and index variable n−1, interface sub-signals corresponding to logic bit 1, logic bit 2, logic bit 3, . . . , and logic bit n are sequentially generated through a loop process, that is, interface sub-signal 1, interface sub-signal 2, interface sub-signal 3, . . . , and interface sub-signal n are obtained, and the interface signal is obtained.

In some examples, after the plurality of interface sub-signals are obtained, the kernel partition is further used for splicing the plurality of interface sub-signals in a generation order of the plurality of interface sub-signals, and obtaining the interface signal.

In an illustrative example, the kernel partition is further used for initializing an output signal of the second interface to a low level before the control step. Since a default level state is low level according to a transmission protocol specification of the predetermined interface protocol, in the example, the output of the second interface is initialized to the low level. When the first timer and the second timer are turned on, the output is set higher through the second interface to output the first signal in a high level.

In order to further implement simulation of the interface signal of the first interface by software and further avoid upgrading an architecture of the BMC chip or investing hardware, in yet another optional embodiment, the kernel partition is further used for controlling the first timer and the second timer to start timing; setting an output signal of the second interface to a high level, and outputting the first signal at the high level through the second interface; and in a case that the timing duration of the first timer reaches the first duration, stopping outputting the first signal and setting an output signal of the second interface to a low level.

In some examples, the kernel partition is further used for triggering a first interruption in the case that the timing duration of the first timer reaches the first duration to stop outputting the first signal. By triggering the first interruption, the first timer is turned off to control the duration of the high level in the interface sub-signal, further implementing conversion of different logic bits.

In some examples, the first interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the first interruption and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

In order to further implement simulation of the interface signal of the first interface by software and further avoid upgrading an architecture of the BMC chip or investing hardware, according to yet another illustrative example, the kernel partition is further used for in a case that the timing duration of the first timer reaches the first duration, setting an output signal of the second interface to a low level, and outputting the second signal in the low level through the second interface; and in a case that the timing duration of the second timer reaches the second duration, stopping outputting the second signal, and setting an output signal of the second interface to a high level to obtain the interface sub-signal.

In some examples, the kernel partition is further used for triggering a second interruption in the case that the timing duration of the second timer reaches the second duration to stop outputting the second signal. By triggering the second interruption, the second timer is turned off to control the duration of the interface sub-signal, and it is further guaranteed that each interface sub-signal with the same duration can be obtained more accurately.

In some examples, each time the second interruption is triggered, timing counting is performed once. The timing counting represents the number of logic bits that have completed conversion.

Further, the second interruption may carry position information of a logic bit currently converted. The kernel partition may obtain a position of a logic bit to be currently subjected to signal conversion through the position information. Certainly, the kernel partition may also determine the position of the logic bit to be currently subjected to signal conversion by counting a number of times of triggering the second interruption and in the order of the logic bits. The kernel partition may also determine the position of the logic bit to be currently subjected to signal conversion by the timing counting and in the order of the logic bits. In this way, when a fault occurs in a conversion process, no signal conversion is required to be repeated for a logic bit that has completed signal conversion processing after fault recovery, such that signal conversion efficiency is improved, waste of calculation resources of the kernel partition is avoided, and conversion operations of the logic bit to be converted is implemented more efficiently.

During application, a person skilled in the art may flexibly set a structure form of the control instruction. In an optional solution, a data structure of the control instruction comprises an address rate field, a target address field, a message rate field, a write length field and a read length field, wherein the address rate field represents a transmission rate of address data, the target address field represents address data of the hardware partition, and the message rate field represents a transmission rate of message data. The write length field represents write operation information of the kernel partition. The read length field represents read operation information of the kernel partition.

For example, when the control instruction is the first instruction used for determining whether the hardware partition exists, a message transmission format of the first instruction is as shown in FIG. 4. The address rate field is two logic bits 0, and the message rate field is one logic bit 0. The target address field, the write length field and the read length field are all 8 logical bits. The target address field is determined by the hardware design of the hardware partition and is typically 0x30 (0x represents a hexadecimal number). The write length field and the read length field are both 0x00. The above fields are all completed by a write operation initiated by the kernel partition.

Further, the kernel partition is further used for receiving, after the transmitting the interface signal to the first interface through a second interface, a response instruction generated by the hardware partition in response to the control instruction, wherein the response instruction comprises the control instruction and a frame check field. The response instruction generated by the hardware partition in response to the control instruction includes not only information of the control instruction, but also a frame check field located at a tail of the control instruction. Information recognizable by the second interface is obtained through conversion, and the field format shown in FIG. 4 is obtained.

In an illustrative example, the first interface comprises a platform environment control interface (PECI), and the second interface comprises a general-purpose input/output (GPIO) interface. That is to say, the kernel partition of the present application simulates a PECI signal through the GPIO interface, and transmits the PECI signal to the PECI of the hardware partition through the GPIO interface. Thus expansion of a PECI link between the BMC and the host system. Then an effect of independently managing the hardware partitions of the host system of the server through the kernel partitions of the BMC without performing hardware logic design on the BMC chip is further achieved. An ability of one BMC chip to independently monitor the plurality of hardware partitions of the host system is further achieved.

In some examples, the first interface comprises a platform environment control interface (PECI), and the second interface comprises a general-purpose input/output (GPIO) interface. The PECI is an interface for information exchange between the BMC and a processor of the host system. The PECI is an important interface in the server, and is mainly responsible for obtaining a CPU temperature, power consumption and failure state information of key unit modules such as a CPU, a UPI link, a memory controller, and a PCIe link, and provide a powerful guarantee for health status monitoring, fault analysis and positioning of a server system. The BMC has a plurality of GPIO interfaces, such that no additional hardware overhead is introduced when the technical solution of the present application is implemented.

In order to further implement expansion of a communication link between the BMC chip and the host system, and further achieve an effect that one BMC chip monitors a plurality of hardware partitions of the host system, according to some other examples, as shown in FIG. 7, one kernel partition of more than one kernel partitions 201 includes a third interface 203. The other kernel partitions 201, excluding the one kernel partition, of the more than one kernel partitions each includes the second interfaces 202. Each of more than one hardware partitions 101 include the first interfaces 102. An interface type of the third interface 203 is identical to an interface type of the first interface 102. The kernel partition is further used for transmitting the control instruction to the corresponding first interface through the third interface. In the examples, one of the kernel partitions is connected to the first interface of one hardware partition through the third interface, and other kernel partitions are connected to the first interfaces of other hardware partitions through the second interfaces in a one-to-one corresponding manner. That is to say, the kernel partitions of the BMC monitor the hardware partitions in a one-to-one corresponding manner through a physical link formed by the third interface and the first interface, or through physical links formed by the second interfaces and the first interfaces. Thus one BMC management unit independently manages the plurality of hardware partitions, and independence of fault management functions of different partition systems of a unified server platform is further guaranteed.

In some examples, the third interface is also a PECI. In the related art, one BMC chip only has one PECI, that is, only one PECI link can be established with the host system through the PECI. According to the solution of the present application, besides the PECI link is retained, a PECI protocol is simulated through the plurality of GPIO interfaces of the BMC chip, such that one-to-one corresponding PECI links are established with PECIs of other hardware partitions of the host system through the GPIO interfaces. Expansion of the PECI links is implemented. The kernel partitions of the BMC can monitor the hardware partitions one to one.

Reference may be made to the instances described in the above examples and the illustrative embodiments for the optional instances in the example, which will not be repeated in the example.

Apparently, those skilled in the art should understand that all the modules or steps above of the present application can be implemented through a general-purpose computation apparatus, centralized on a single computation apparatus or distributed over a network composed of a plurality of computation apparatuses, and implemented through program codes executable by the computation apparatus. Therefore, the modules or steps can be stored in a storage apparatus to be executed by the computation apparatus. In some cases, the steps shown or described can be executed in a different order from herein. Alternatively, some or all of the modules or the steps can be implemented by fabricating same into individual integrated circuit modules separately. In this way, the present application is not limited to any particular combination of hardware and software.

What are described above are merely optional examples of the present application, and are not intended to limit the present application. Those skilled in the art can make various changes and variations to the present application. Any modifications, equivalent replacements, improvements, etc. made within the principles of the present application should fall within the scope of protection of the present application.

1. A method for interface communication, wherein a host system of a server comprises a hardware partition, a baseboard management controller (BMC) comprises a kernel partition, the kernel partition is configured to manage the hardware partition, and the method comprises:
generating a control instruction for controlling the hardware partition;
converting the control instruction into an interface signal conforming to a predetermined interface protocol, wherein the predetermined interface protocol is an interface protocol of a first interface of the hardware partition; and
transmitting the interface signal to the first interface through a second interface, wherein an interface type of the first interface is different from an interface type of the second interface.

2. The method according to claim 1, wherein the converting the control instruction into an interface signal conforming to a predetermined interface protocol comprises:
determining a plurality of pieces of logic bit information corresponding to the control instruction according to the predetermined interface protocol; and
generating the interface signal according to the plurality of pieces of logic bit information, a first timer, and a second timer.

3. The method according to claim 2, wherein the generating the interface signal according to the plurality of pieces of logic bit information, a first timer and a second timer comprises:
determining timing duration of the first timer and timing duration of the second timer according to the plurality of pieces of logic bit information; and
generating the interface signal through the second interface according to the timing duration of the first timer and the timing duration of the second timer.

4. The method according to claim 3, wherein the determining timing duration of the first timer and timing duration of the second timer according to the plurality of pieces of logic bit information comprises:
obtaining first duration and second duration corresponding to each piece of logic bit information in the plurality of pieces of logic bit information, wherein the first duration represents duration in which the each piece of logic bit information is at a high level, the second duration represents total duration of the each piece of logic bit information, and the first duration corresponding to different pieces of logic bit information in the plurality of pieces of logic bit information is different; and
determining that the timing duration of the first timer is the first duration, and determining that the timing duration of the second timer is the second duration.

5. The method according to claim 4, wherein the generating the interface signal through the second interface according to the timing duration of the first timer and the timing duration of the second timer comprises:
sequentially generating, by the second interface, an interface sub-signal corresponding to each piece of logic bit information in the plurality of pieces of logic bit information in an order of the plurality of pieces of logic bit information according to the first duration of the first timer and the second duration of the second timer, to obtain the interface signal.

6. The method according to claim 5, wherein the sequentially generating, by the second interface, an interface sub-signal corresponding to the each piece of logic bit information in the plurality of pieces of logic bit information in an order of the plurality of pieces of logic bit information according to the first duration of the first timer and the second duration of the second timer, to obtain the interface signal comprise:
a control step: controlling the first timer and the second timer to start timing, and outputting a first signal through the second interface before the timing duration of the first timer reaches the first duration;
an output step: outputting a second signal through the second interface after the timing duration of the first timer reaches the first duration and before the timing duration of the second timer reaches the second duration, to obtain the interface sub-signal composed of the first signal and the second signal;
a count step: performing a timing counting operation in a case that the timing duration of the second timer reaches the second duration; and
a determination step: determining whether a timing counting value obtained from the timing counting operation is less than a total number of the plurality of pieces of the logic bit information; in a case that the timing counting value is less than the total number of the plurality of pieces of logic bit information, sequentially performing the control step, the output step, and the count step in the order until the timing counting value is not less than the total number of the plurality of pieces of logic bit information, to obtain the interface signal comprising a plurality of interface sub-signals.

7. The method according to claim 6, further comprising:
initializing an output signal of the second interface to a low level before the control step.

8. The method according to claim 6, wherein the control step comprises:
controlling the first timer and the second timer to start timing;
setting an output signal of the second interface to a high level, and outputting the first signal at the high level through the second interface; and
in a case that the timing duration of the first timer reaches the first duration, stopping outputting the first signal and setting an output signal of the second interface to a low level.

9. The method according to claim 8, wherein in a case that the timing duration of the first timer reaches the first duration, the stopping outputting the first signal comprises:
triggering a first interruption in the case that the timing duration of the first timer reaches the first duration to stop outputting the first signal.

10. The method according to claim 6, wherein the output step comprises:
in a case that the timing duration of the first timer reaches the first duration, setting an output signal of the second interface to a low level, and outputting the second signal in the low level through the second interface; and
in a case that the timing duration of the second timer reaches the second duration, stopping outputting the second signal, and setting an output signal of the second interface to a high level to obtain the interface sub-signal.

11. The method according to claim 10, wherein in a case that the timing duration of the second timer reaches the second duration, the stopping outputting the second signal comprises:
triggering a second interruption in the case that the timing duration of the second timer reaches the second duration to stop outputting the second signal.

12. The method according to claim 1, wherein the control instruction comprises at least one of the following:
a first instruction, configured to determine whether the hardware partition exists;
a second instruction, configured to obtain a sensor temperature of the hardware partition; and
a third instruction, configured to obtain register data of the hardware partition.

13. The method according to claim 1, wherein a data structure of the control instruction comprises an address rate field, a target address field, a message rate field, a write length field and a read length field, wherein the address rate field represents a transmission rate of address data, the target address field represents address data of the hardware partition, and the message rate field represents a transmission rate of message data.

14. The method according to claim 1, wherein after the transmitting the interface signal to the first interface through a second interface, the method further comprises:
receiving a response instruction generated by the hardware partition in response to the control instruction, wherein the response instruction comprises the control instruction and a frame check field.

15. The method according to claim 1, wherein the first interface comprises a platform environment control interface (PECI), and the second interface comprises a general-purpose input/output (GPIO) interface.

16. The method according to claim 1, wherein the quantity of the hardware partition in the host system is more than one, the quantity of the kernel partition in the BMC is more than one, one kernel partition of more than one kernel partitions comprises a third interface, the other kernel partitions, excluding the one kernel partition, of the more than one kernel partitions each comprises the second interface, each of more than one hardware partitions comprises the first interface, an interface type of the third interface is identical to an interface type of the first interface, and the method further comprises:
transmitting the control instruction to the corresponding first interface through the third interface.

17-18. (canceled)

19. An electronic device, comprising a memory, a processor, and a computer program stored on the memory and runnable on the processor, wherein the processor implements steps of the method according to claim 1 when executing the computer program.

20. A server, comprising:
a host system comprising a plurality of hardware partitions, wherein each of the plurality of hardware partitions comprise a first interface; and
a baseboard management controller (BMC) comprising a plurality of kernel partitions, wherein the plurality of kernel partitions correspond one-to-one with the plurality of hardware partitions, at least part of the plurality of kernel partitions each comprise a second interface, an interface type of the first interfaces is different from an interface type of the second interface, and
wherein each of at least part of the plurality of kernel partitions is configured to generate a control instruction to control a corresponding hardware partition in the plurality of hardware partitions; and convert the control instruction into an interface signal conforming to a predetermined interface protocol, wherein the predetermined interface protocol is an interface protocol of the first interface of each of the plurality of the hardware partitions; and transmit the interface signal to the first interface through the second interface.

21. The server according to claim 20, wherein each of at least part of the plurality of kernel partitions is further configured to determine a plurality of pieces of logic bit information corresponding to the control instruction according to the predetermined interface protocol, and generate the interface signal according to the plurality of pieces of logic bit information, a first timer and a second timer;
or,
wherein one kernel partition of the plurality of kernel partitions comprises a third interface, an interface type of the third interface is identical to an interface type of the first interfaces, the other kernel partitions, excluding the one kernel partition, in the plurality of kernel partitions each comprises the second interface, and the one kernel partition comprising the third interface is configured to transmit the control instruction to the corresponding first interface through the third interface.

22. The server according to claim 21, wherein each of at least part of the plurality of kernel partitions is further configured to generate the interface signal according to the plurality of pieces of logic bit information, a first timer and a second timer by following steps: determining timing duration of the first timer and timing duration of the second timer according to the plurality of pieces of logic bit information, and generating the interface signal through the second interface according to the timing duration of the first timer and the timing duration of the second timer;
each of at least part of the plurality of kernel partitions is further configured to determine timing duration of the first timer and timing duration of the second timer according to the plurality of pieces of logic bit information by following steps: obtaining first duration and second duration corresponding to each piece of logic bit information in the plurality of pieces of logic bit information, wherein the first duration represents duration in which the each piece of logic bit information is at a high level, the second duration represents total duration of the each piece of logic bit information, and the first duration corresponding to different pieces of logic bit information in the plurality of pieces of logic bit information is different; and determining that the timing duration of the first timer is the first duration, and determining that the timing duration of the second timer is the second duration;
each of at least part of the plurality of kernel partitions is further configured to generate the interface signal through the second interface according to the timing duration of the first timer and the timing duration of the second timer by following steps: sequentially generating, by the second interface, an interface sub-signal corresponding to each piece of logic bit information in the plurality of pieces of logic bit information through the second interface in an order of the plurality of pieces of logic bit information according to the first duration of the first timer and the second duration of the second timer, to obtain the interface signal.

23-25. (canceled)
